(19) United States
(12) Patent Application Publication
(10) Pub. No.: US 2014/0362040 A1
(43) Pub. Date: Dec. 11, 2014

(54) CAPACITIVE TOUCH PANEL

(71) Applicant: FOCALTECH SYSTEMS, LTD., GEORGE TOWN (KY)

(72) Inventors: Lianghua MO, Shenzhen (CN); Guang OUYANG, Shenzhen (CN)

(73) Assignee: FOCALTECH SYSTEMS, LTD., GEORGE TOWN (KY)

(21) Appl. No.: 14/292,103

(22) Filed: May 30, 2014

(30) Foreign Application Priority Data
Jun. 6, 2013 (CN) 201310224023.6

(51) Int. Cl. G06F 3/044

(52) U.S. Cl. CPC G06F 3/044
USPC 345/174

(57) ABSTRACT

A capacitive touch panel is provided, which includes a printed circuit board, a plurality of sensing electrodes and a touch control chip. The sensing electrodes are located on the printed circuit board in a two-dimensional array arrangement. The touch control chip is bound to the printed circuit board in a Chip-on-Board manner, and the touch control chip is connected to each of the plurality of sensing electrodes via a wire.

The present application claims the priority to Chinese Patent Application No. 201310224023.6, entitled as “CAPACITIVE TOUCH PANEL”, filed with the Chinese State Intellectual Property Office on Jun. 6, 2013, the entirety of which is incorporated herein by reference.

### FIELD

The disclosure relates to the technical field of touch control, and in particular to a capacitive touch panel.

### BACKGROUND

Touch panels are now widely used in various electronic products such as laptops, display devices, mobile phones and game consoles, thus a user can work movably anytime and anywhere, without peripheral devices. However, existing capacitive touch panels usually have problems such as poor anti-interference performance, low frame scanning rate and complicated manufacturing process.

### SUMMARY

A capacitive touch panel is provided according to an embodiment of the disclosure, including: a printed circuit board; a plurality of sensing electrodes located on the printed circuit board, where the plurality of sensing electrodes are arranged in a two-dimensional array; and a touch control chip bound to the printed circuit board in a Chip-on-Board (COB) manner, where the touch control chip is connected to each of the plurality of sensing electrodes via a wire.

It is further provided a capacitive touch panel, including: a printed circuit board; a plurality of sensing electrodes located on the printed circuit board; and a touch control chip connected to each sensing electrode and configured to detect a self-capacitance of each sensing electrode.

In the embodiments of the disclosure, by adopting the sensing electrodes arranged in a two-dimensional array for the capacitive touch panel, the performance of anti-interference is improved while the multi-touch is achieved. In addition, with the solutions of the embodiments of the disclosure, power supply noise is removed significantly, and interferences from Radio Frequency (RF) and other noise sources such as a display module are decreased.

In the capacitive touch panel according to the embodiments of the disclosure, by connecting the touch control chip to each of the sensing electrodes via a corresponding wire and binding the touch control chip to the printed circuit board in a COB manner, the increasing chip size and the increasing packaging cost caused by the large numbers of pins can be reduced.

In the embodiments of the disclosure, by driving and detecting an electrode being detected and simultaneously driving the rest of the sensing electrodes or sensing electrodes around the electrode being detected, the capacitance and thus the resistance of the electrode being detected can be reduced. In addition, the time for scanning the electrodes can be reduced by detecting the sensing electrodes simultaneously or by group. Accordingly, problems caused by the large numbers of sensing electrodes are reduced.

### BRIEF DESCRIPTION OF THE DRAWINGS

FIG. 1 is a schematic diagram of a capacitive touch panel according to a first embodiment of the disclosure.

FIG. 2A is a schematic planar diagram of a capacitive touch panel according to a second embodiment of the disclosure.

FIG. 2B is a schematic lateral view of the capacitive touch panel according to the second embodiment of the disclosure.

FIG. 3 is a top view of a sensing electrode array according to the second embodiment of the disclosure.

FIG. 4 to FIG. 7 illustrate a sensing electrode driving method according to a third embodiment of the disclosure.

FIG. 8 illustrates four application scenarios of a capacitive touch panel according to the third embodiment of the disclosure.

FIG. 9 illustrates a signal flowchart of a touch control chip according to the third embodiment of the disclosure.

FIG. 10A illustrates an example of calculating coordinates of a touch position by a centroid algorithm according to a fourth embodiment of the disclosure.

FIG. 10B illustrates an example of calculating coordinates of a touch position by a centroid algorithm with presence of noises according to the fourth embodiment of the disclosure.

### DETAILED DESCRIPTION

For better understanding of objectives, features and advantages of the disclosure, the technical solution in the embodiments of the application is described hereinafter in conjunction with drawings. Apparently, the embodiments described are merely some embodiments of the application. Any other embodiments obtained based on the embodiments in the application by those skilled in the art without any creative works should fall within the scope of the application. For convenience of illustration, sectional views showing the structure of the device are enlarged partially and are not drawn to scale. The drawings are exemplary and are not intended to limit the scope of the invention. Furthermore, in the actual manufacture process, three-dimensional sizes, i.e. length, width and depth should be considered.

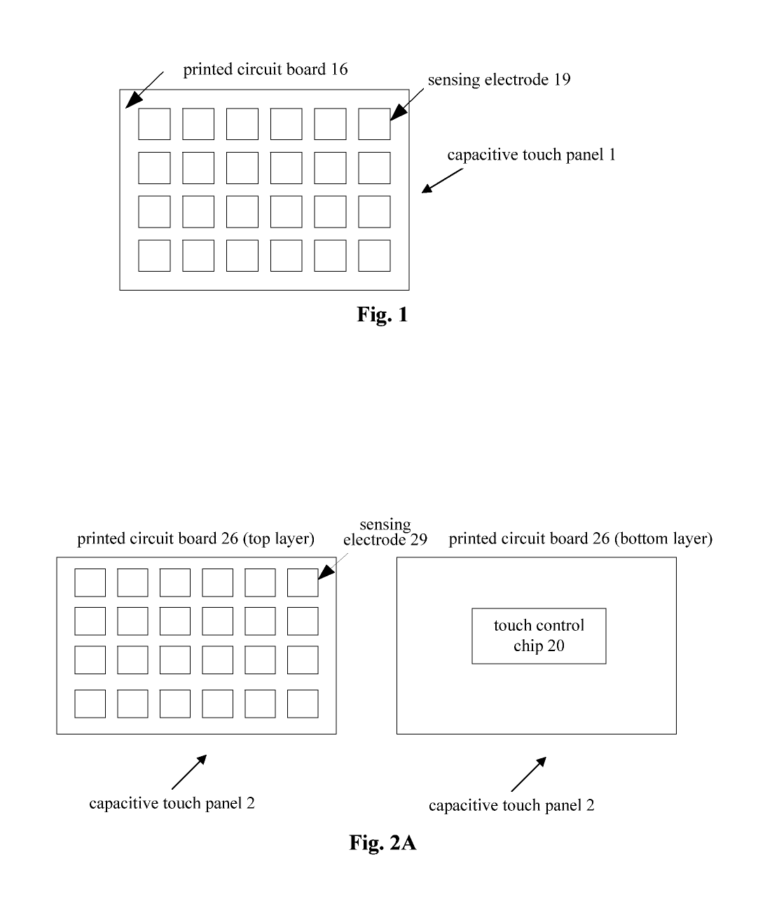

FIG. 1 is a schematic diagram of a capacitive touch panel according to a first embodiment of the disclosure. As shown in FIG. 1, the capacitive touch panel 1 includes a printed circuit board 16, a plurality of sensing electrodes 19, and a touch control chip (not shown in FIG. 1). The sensing electrodes 19 are located on the printed circuit board 16 in a two-dimensional array arrangement. The touch control chip is bound to the printed circuit board 16 in a Chip-on-Board (COB) manner. The touch control chip is connected to each of the plurality of sensing electrodes 19 via a corresponding wire (not shown in FIG. 1).

The plurality of sensing electrodes 19 may be arranged in a rectangular array or a two-dimensional array with other shapes. Each of the sensing electrodes 19 is a capacitive sensor for the capacitive touch panel 1. A capacitance of the capacitive sensor changes when a position where the capacitive sensor is located on the capacitive touch panel 1 is touched. By adopting the sensing electrodes 19 arranged in a two-dimensional array, the performance of anti-interference is improved while the multi-touch is achieved, power supply noise is removed, and interferences from Radio Frequency (RF) and other noise sources such as a liquid crystal display module are reduced. Further description is given in detail in conjunction with a fourth embodiment.

Each of the sensing electrodes 19 is connected to the touch control chip via a wire (not shown in FIG. 1). The touch control chip is bound to the printed circuit board 16 in a COB manner. Since all the sensing electrodes 19 are connected to the touch control chip via the wires, the touch control chip has large number of pins. Difficulties in normal packaging and the increasing chip size and the increasing packaging cost caused by the large number of pins can be reduced by binding the touch control chip to the printed circuit board 16 in a COB manner. The touch control chip is a wafer without packaging, that is, the touch control chip needs not to be packaged. Accordingly, the touch control chip occupies a small area on the printed circuit board 16, and the costs for packaging the chip, package testing and overall materials of the capacitive touch panel 1 are reduced. In addition, with the COB manner, the touch control chip and the capacitive touch panel 1 are integrated, which reduces the distance between the touch control chip and the capacitive touch panel 1, and the overall size is reduced.

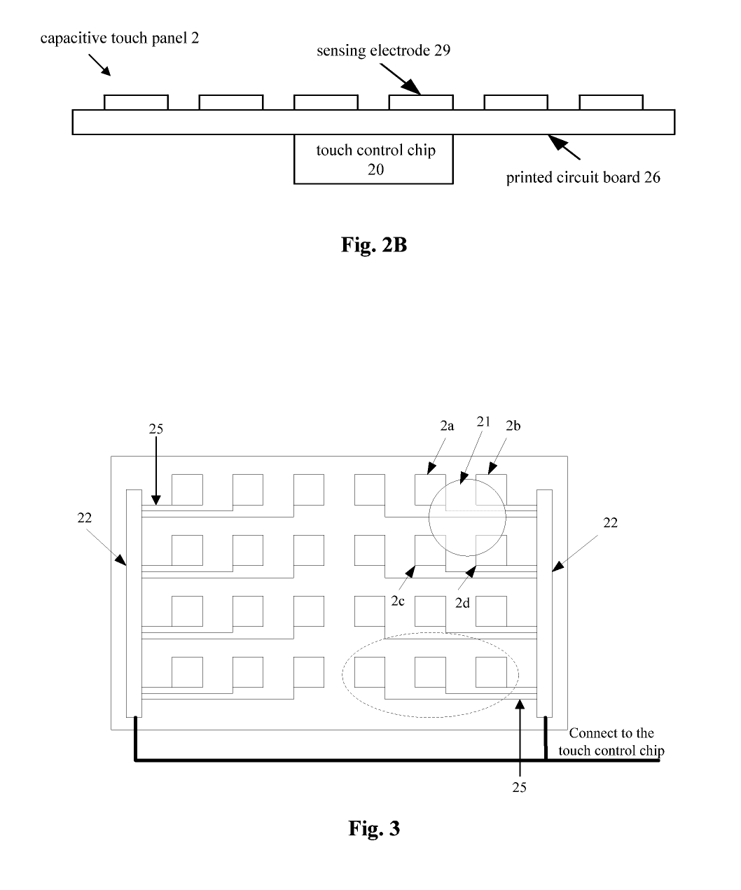

FIG. 2A is a schematic planar diagram of a capacitive touch panel according to a second embodiment of the disclosure. FIG. 2B is a schematic lateral view of the capacitive touch panel according to the second embodiment of the disclosure.

As shown in FIG. 2A and FIG. 2B, the capacitive touch panel 2 includes: a double-layer printed circuit board 26, a plurality of sensing electrodes 29, and a touch control chip 20. The sensing electrodes 29 are located on a top layer of the double-layer printed circuit board 26 in a two-dimensional array arrangement. The touch control chip 20 is bound to a bottom layer of the printed circuit board 26 in a Chip-on-Board (COB) manner. The touch control chip 20 is connected to each of the plurality of sensing electrodes 29 via a corresponding wire.

As an example, the wire may be connected to the touch control chip 20 through a via hole (not shown).

It should be understood by those skilled in the art that only one exemplary arrangement of the sensing electrodes 29 is shown in FIG. 2A, and any two-dimensional array can be adapted for the arrangement of the sensing electrodes 29 in practice. In addition, the distance between any two adjacent sensing electrodes 29 in any direction can be equal or not. It is also to be understood by those skilled in the art that there may be more sensing electrodes than those shown in FIG. 2A.

It should be understood by those skilled in the art that FIG. 2A only illustrates one exemplary shape of the sensing electrodes 29. The sensing electrodes 29 may be, rectangular, rhombic, circular, elliptic or even in an irregular shape for example in other embodiments. Periphery of the sensing electrodes 29 may further be sawtooth pattern for example The sensing electrodes 29 may have the same or different patterns. For example, the sensing electrodes 29 in the middle are rhombic while the sensing electrodes 29 at periphery are triangular.

In addition, the sensing electrodes 29 may be in the same or different sizes. For example, the sensing electrodes 29 in the middle are bigger than the sensing electrodes 29 at periphery, which is advantageous for the wiring and for the touch accuracy at periphery.

FIG. 3 is a top view of a sensing electrode array according to the second embodiment of the disclosure. A sensing electrode array shown in FIG. 3 is based on a self-capacitance touch detection theory. In FIG. 3, each sensing electrode 29 corresponds to a predetermined position on the capacitive touch panel 2, reference numbers 2a-2d represent different sensing electrodes 29, and reference numeral 21 represents a touch. The electric charges on a sensing electrode 29 change when a touch occurs on the position corresponding to the sensing electrode 29. Accordingly, whether a touch event occurs on the sensing electrode 29 is determined by detecting the electric charges (current/voltage) on the sensing electrode 29, which may be implemented by means of analog-to-digital conversion through an Analog-to-Digital Converter (ADC). The change of the electric charges on the sensing electrode 29 is related to the area of the sensing electrode 29 that is covered by the touch 21, for example, the change of the electric charges on the sensing electrode 2b or 2d is more than that on the sensing electrode 2a or 2c in FIG. 3.

Since each sensing electrode 29 is located on a predetermined position of the capacitive touch panel 2, and the sensing electrodes 29 are not physically connected with one another, not only the multi-touch can be achieved actually, but also a phenomenon of ghost points in the self-capacitance touch detection and errors caused by noise transmitting among the sensing electrodes 29 are reduced. Accordingly, the Signal Noise Ratio is enhanced.

As an example, in FIG. 3, each sensing electrode 29 may be connected to a bus 22 via a wire 25 and then be connected to the touch control chip 20.

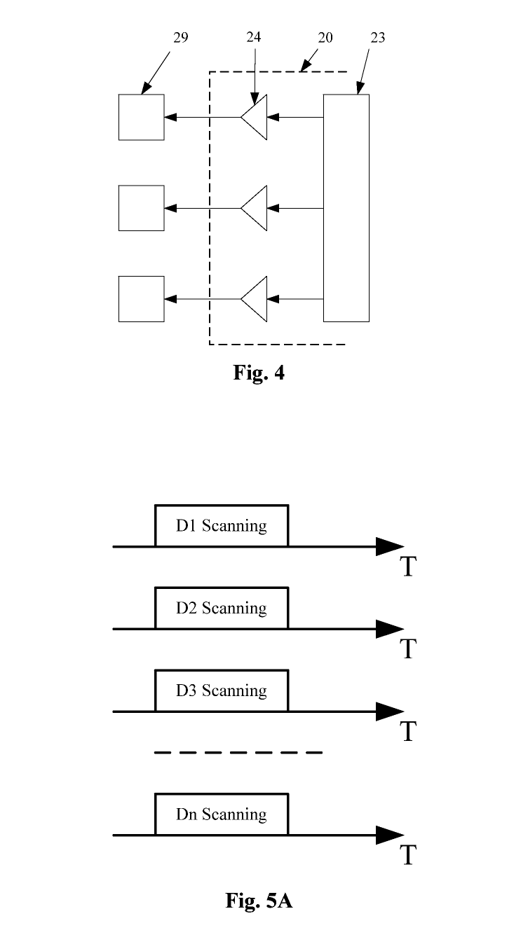

FIG. 4 to FIG. 7 illustrate a sensing electrode driving method for a capacitive touch panel according to the third embodiment of the disclosure. The sensing electrode driving method is described below by using the capacitive touch panel 2. It should be noted that the sensing electrode driving method may also be applied to the capacitive touch panel 1 or other capacitive touch panels.

As shown in FIG. 4, the touch control chip 20 includes driving sources 24 and a timing control circuit 23. A sensing electrode 29 is driven by the driving source 24, which can be a voltage source or a current source. The driving sources 24 for driving different sensing electrodes 29 may have different structures. For example, some of the driving sources are voltage sources and some are current sources. In addition, the driving sources 24 for driving different sensing electrodes 29 may have a same frequency or not. The operating sequences of the driving sources 24 are controlled by the timing control circuit 23.

Taking n sensing electrodes (D1, D2 . . . Dj, Dk . . . Dn) as an example, driving methods for the sensing electrodes 29 are respectively described as follows.

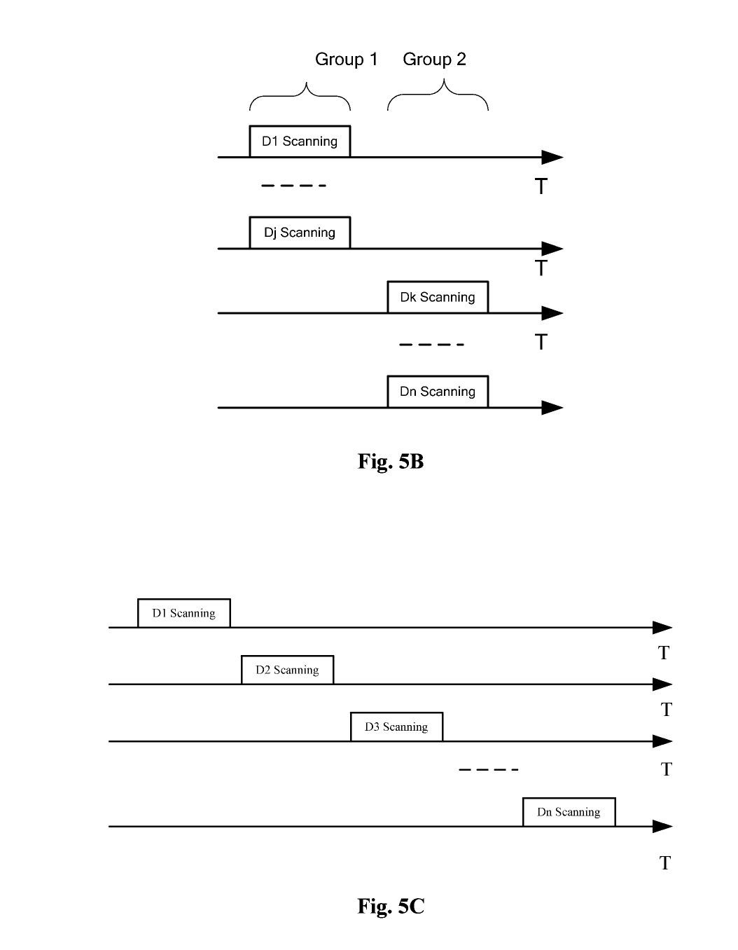

As shown in FIG. 5A, all of the sensing electrodes D1, D2 . . . Dj, Dk . . . Dn are driven and detected simultaneously. For this driving method, the time to complete a scanning for all the sensing electrodes D1, D2 . . . Dj, Dk . . . Dn is the shortest, while the number of the driving sources is the most (the same as the number of the sensing electrodes D1, D2 . . . Dj, Dk . . . Dn). As shown in FIG. 5B, the sensing electrodes D1, D2 . . . Dj, Dk . . . Dn are divided into several groups. The sensing electrodes D1, D2 . . . Dj, Dk . . . Dn in the same group are simultaneously scanned. The sensing electrodes D1, D2 . . . Dj, Dk . . . Dn in different groups are sequentially scanned. Accordingly, the number of driving sources is reduced while the scanning time for all the sensing electrodes D1, D2 . . . Dj, Dk . . . Dn is increased.

FIG. 5C illustrates a conventional driving method for the sensing electrodes D1, D2 . . . Dj, Dk . . . Dn. The sensing electrodes D1, D2 . . . Dj, Dk . . . Dn are scanned sequentially. If a scanning time of each sensing electrode D1, D2 . . . Dj, Dk . . . Dn is Ts, the scanning time for all the sensing electrodes D1, D2 . . . Dj, Dk . . . Dn is n*Ts. With the sensing electrode driving method according to the embodiments of the disclosure, all the sensing electrodes D1, D2 . . . Dj, Dk . . . Dn are scanned simultaneously, and the shortest scanning time for all the sensing electrodes D1, D2 . . . Dj, Dk . . . Dn is only Ts. That is, the scan frequency can be enhanced by N times with the driving method according to the embodiments of the disclosure compared with the conventional driving method.

For a mutual capacitance touch panel 2 including 40 driving channels, if a scanning time for each driving channel is 500 μs, the scanning time for the whole touch panel 2 (one frame) is 20 ms, i.e., the frame frequency is 50 Hz, which is usually inadequate for good usage experience. The problem can be solved by the embodiments of the disclosure. By arranging the sensing electrodes D1, D2 . . . Dj, Dk . . . Dn in a two-dimensional array, all the sensing electrodes D1, D2 . . . Dj, Dk . . . Dn may be scanned simultaneously, and the frame frequency reaches 2000 Hz under a condition that the scanning time for each sensing electrode D1, D2 . . . Dj, Dk . . . Dn keeps at 500 μs, which is highly above application requirements of conventional mutual capacitance touch panels.

In the embodiment, the self-capacitance of each sensing electrode 29 is detected. The self-capacitance of the sensing electrode 29 may be a capacitance of the sensing electrode to the ground.

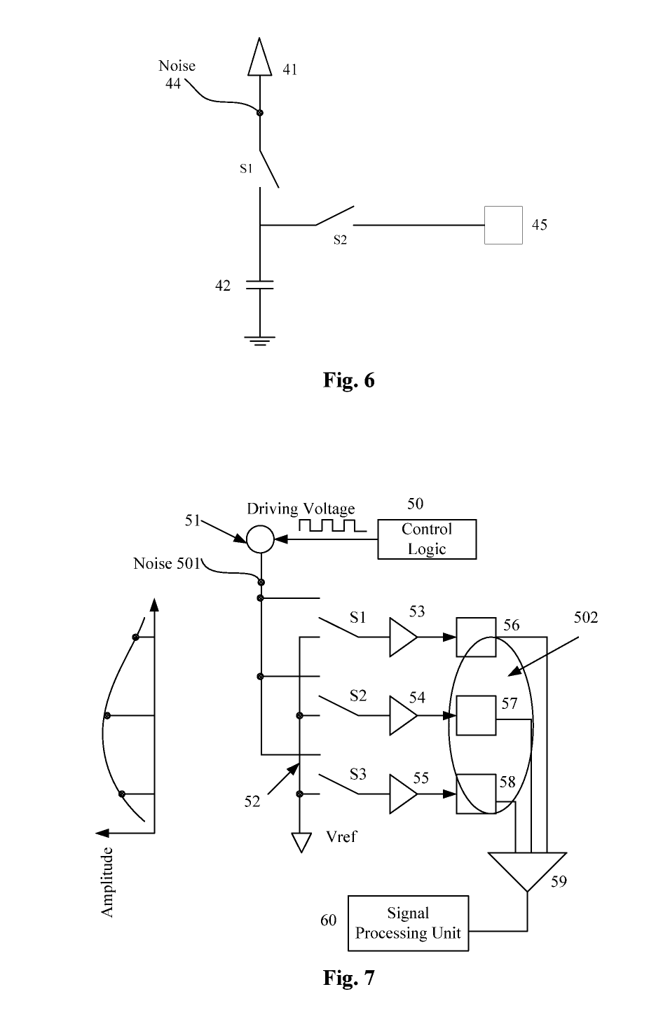

For example, an electric charge detection may be adopted to detect the self-capacitance of each sensing electrode 29. As shown in FIG. 6, a constant voltage V₁ is provided by a driving source 41. The voltage V₁ may be positive, negative or equivalent to the ground. References S1 and S2 represent two control switches, a reference number 42 represents a capacitor of the sensing electrode to the ground, and a reference number 45 represents an electric charge receiving module which clamps a voltage applied to the sensing electrode 29 to a predetermined voltage V2 and measures quantity of electric charges transferred from the sensing electrode 29. Firstly, the control switch S1 is switched on and the control switch S2 is switched off, the upper plate of the capacitor 42 is charged to the voltage V1. Then, the control switch S1 is switched off and the control switch S2 is switched on, the capacitor 42 exchanges electric charges with the electric charge receiving module 45. Assuming that the quantity of the transferred electric charges is Q1 and the voltage on the upper plate of the capacitor 42 is changed to the predetermined voltage V2, a capacitance Cx of the capacitor 42 is calculated by a formula Cx=Q1/(V2−V1). Accordingly, the self-capacitance detection is implemented.

In other embodiments, the self-capacitance of each sensing electrode 29 may be detected using a current source, or frequency of the sensing electrode 29.

Alternatively, in a case that a plurality of driving sources are provided to drive and detect the sensing electrodes 29, when a sensing electrode 29 is detected, a voltage different from the voltage applied to the sensing electrode 29 being detected is simultaneously provided to the sensing electrodes 29 adjacent to or around the sensing electrode 29 being detected. For convenient illustration, FIG. 7 shows only three sensing electrodes including a sensing electrode 57 being detected and two sensing electrodes 56, 58 adjacent to the sensing electrode 57. It should be understood by those skilled in the art that the following example is also applicable to embodiments with more sensing electrodes.

The touch control chip 20 not only includes the driving sources 24 and the timing control circuit 23 shown in FIG. 4, but also includes a signal driving unit 50, a voltage source 51, a signal receiving unit 59 and a signal processing unit 60, as shown in FIG. 7. In FIG. 7, the timing control circuit 23 is implemented as control switches S1-S3 and corresponding switch control circuits (not shown), and the driving sources 24 are implemented as driving sources 53-55. The driving sources 53-55 may be similar or different.

The driving source 54 is connected to the sensing electrode 57, and is further connected to the voltage source 51 via the switch S2. The voltage source 51 is further connected to the signal driving unit 50. The driving source 54 is configured to drive the sensing electrode 57. The sensing electrodes 56 and 58 are respectively connected to driving sources 53 and 55. The driving source 53 is further connected to the voltage source 51 or a predetermined reference voltage 52 (Vref, e.g., the ground) via a switch S1. The driving source 55 is further connected to the voltage source 51 or the predetermined reference voltage 52 via a switch S3. The sensing electrodes 56, 57, 58 are connected to a signal receiving unit 59. The sensing electrode 57 being detected and the sensing electrodes 56 and 58 adjacent to the sensing electrode 57 being detected are simultaneously driven by the same voltage if the switches S1 and S3 are connected to the voltage source 51. In this case, the voltage differences between the sensing electrode 57 being detected and the sensing electrodes 56 and 58 adjacent to the sensing electrode 57 being detected are reduced, which is advantageous to reduce the capacitance of the sensing electrode 57 being detected and prevent a false touch caused by a water drop.

Preferably, the touch control chip 20 is configured to adjust sensitivity or a dynamic range of touch detection by means of one or more parameters of each driving source 53, 54, 55. The one or more parameters include any one or any combination of amplitude, frequency and time sequence. As shown in FIG. 7, for example, the parameters (e.g., the driving voltage, current and frequency) of the driving sources 53, 54, and 55 and the time sequence of the driving sources 53, 54, and 55 may be controlled by a control logic of the signal driving unit 50 in the touch control chip 20. The operating mode such as a high sensitivity mode, a medium sensitivity mode and a low sensitivity mode, or the dynamic range of the touch detection may be adjusted by means of the one or more parameters.

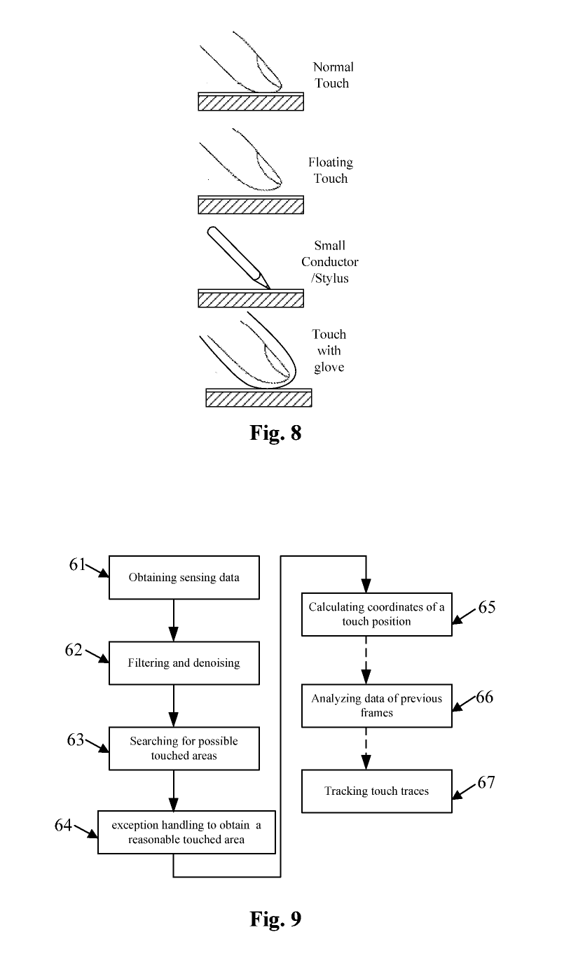

Different operating modes may be used in different application scenarios. FIG. 8 illustrates four application scenarios of a capacitive touch panel according to a third embodiment of the disclosure. The four application scenarios include a normal finger touch, a floating finger touch, a touch with an active/passive stylus or a small conductor, and a touch with a glove. One or more normal touches and one or more touches with small conductors are detected in conjunction with the one or more parameters described above. It should be understood by those skilled in the art that, although the signal receiving unit 59 is separated from the signal driving unit 50 in FIG. 7, the signal receiving unit 59 and the signal driving unit 50 may be integrated in one circuit in other embodiments.

FIG. 9 illustrates a signal flowchart of the touch control chip 20 according to the third embodiment of the disclosure. It should be noted that the signal flowchart is also applicable to the touch control chip in the first embodiment. The capacitance of a sensing electrode 29 changes when a touch occurs on the position corresponding to the sensing electrode 29, and the change is converted into a digital value via an analog-to-digital (ADC) to determine information of the touch. Generally, the change of the capacitance is related to the area of the sensing electrode 29 that is covered by the touch. The signal receiving unit 59 receives sensing data from the sensing electrode 29 and the information of the touch is determined by the signal processing unit 60 connected to the signal receiving unit 59 based on the sensing data.

As an example, a data processing method of the signal processing unit is described as follows.

In Step 61, the sensing data is obtained.

In Step 62, filtering and denoising is performed on the sensing data. The step 62 is used to reduce noise from the sensing data, so as to be convenient to subsequent calculation. Spatial-domain filtering, time-domain filtering, or threshold filtering may be used in this step, for example

In Step 63, possible touch regions are searched for. The possible touch regions include an actual touch region and a false region caused by an invalid signal. The invalid signal includes, for example, a large-area touch signal, a power supply noise signal, a suspending abnormal signal, and a water drop signal. Some invalid signals may be similar to the actual touch, some may interfere with the actual touch, and some may not be determined as a normal touch.

In Step 64, exception handling is performed, so as to remove the above invalid signals and obtain the actual touch region.

In Step 65, coordinates of the obtained actual touch region are calculated.

The coordinates of the actual touch region are determined based on a two-dimensional capacitance sensing array. In detail, the coordinates of the actual touch region is calculated by a centroid algorithm based on the two-dimensional capacitance sensing array.

As an example, the touch control chip 20 may include a signal driving/receiving unit and a signal processing unit. The signal driving/receiving unit is configured to drive each sensing electrode 29 and receive sensing data from each sensing electrode 29. The signal processing unit is configured to determine a touch position based on the sensing data. In detail, the signal driving/receiving unit is configured to drive the sensing electrodes 29 with a voltage source or a current source. The signal processing unit is configured to calculate self-capacitance (e.g., the capacitance to the ground) of each sensing electrode 29 by means of the voltage, frequency or quantity of electric charge of the corresponding sensing electrode 29 and determine the touch position based on the change of the self-capacitances.

In addition, the signal driving/receiving unit is configured to drive and detect a sensing electrode 29 and simultaneously drive the rest of the sensing electrodes 29, or drive and detect a sensing electrode 29 and simultaneously drive sensing electrodes 29 around the sensing electrode 29.

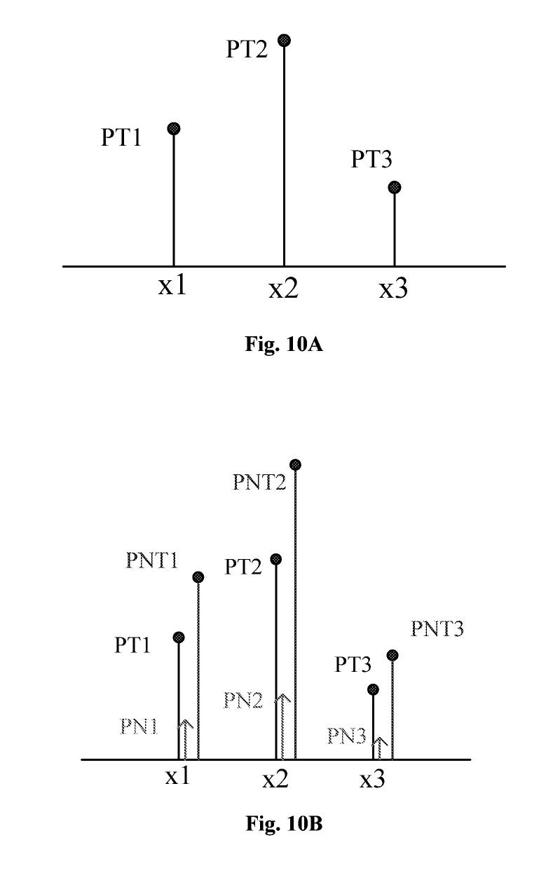

FIG. 10A illustrates an example of calculating coordinates of the actual touch region by a centroid algorithm according to a fourth embodiment of the disclosure. The fourth embodiment is described by using the capacitive touch panel 2 herein. It should be noted that fourth embodiment is also applicable to the capacitive touch panel 1. A calculation of the coordinates of the actual touch region in one dimension is illustrated in the following for brevity. It should be understood by those skilled in the art that, the coordinates of the actual touch region in three dimensions may be obtained with the same or similar method. If the sensing electrodes 56 to 58 shown in FIG. 7 are covered by finger(s), the sensing data corresponding to the sensing electrodes 56 to 58 are PT1, PT2 and PT3, respectively, and coordinates of the sensing electrodes 56 to 58 are x1, x2 and x3, respectively, then the coordinate of the actual touch region obtained by the centroid algorithm is

$${X}_{touch} = \frac{PT 1 * x 1 + PT 2 * x 2 + PT 3 * x 3}{PT 1 + PT 2 + PT 3} \qquad ( 1 )$$

Optionally, step 66 which includes analyzing sensing data of previous frames and obtaining sensing data of a current frame based on the data of the previous frames is performed after the coordinates of the actual touch region are obtained.

Optionally, step 67 which includes tracking a touch trace based on sensing data of multiple frames is performed after the coordinates of the actual touch region are obtained.

With the capacitive touch panel 2 according to the embodiment of the disclosure, noise superposition is reduced while the multi-touch is achieved.

In the capacitive touch panel 2 according to the embodiments of the disclosure, the sensing electrodes 29 are not physically connected with each other outside the touch control chip 20, therefore, the noises are not transmitted through all receiving channels (RXs) and are not be transmitted and superimposed among the sensing electrodes 29, and the false detections are reduced. Taking a power supply common-mode noise introduced into a position 501 shown in FIG. 7 as an example, the noise is not transmitted among the sensing electrodes 29 and thus does not cause the false detection.

For example, the sensing electrodes 29 are detected by means of voltage. The voltage on a touched sensing electrode 29 changes because of the noise, and the sensing data of the touched sensing electrode 29 changes consequently. According to a theory of self-capacitance touch detection, the sensing data caused by the noise and the sensing data caused by a normal touch are both in direct proportion to the covered area of the touched sending electrode.

FIG. 10B illustrates another example of calculating the coordinates of a touch position by the centroid algorithm with presence of noises according to the fourth embodiment of the disclosure. If the sensing data caused by a normal touch are PT1, PT2 and PT3, and the sensing data caused by the noises are PN1, PN2 and PN3, then (taking the sensing electrodes 56 to 58 as an example):

PT1∝C58, PT2∝C57, PT3∝C56.

PN1∝C58, PN2∝C57, PN3∝C56,

wherein PN1=K*PT1, PN2=K*PT2, PN3=K*PT3, K is a constant.

If the polarities of the voltages of the noise and the driving source are the same, the sensing data because of a voltage superposition respectively are:

PNT1=PN1+PT1=(1+K)*PT1

PNT2=PN2+PT2=(1+K)*PT2

PNT3=PN3+PT3=(1+K)*PT3.

Therefore, the coordinates obtained by the centroid algorithm is:

$$\begin{matrix}{X}_{touch} = \frac{PNT 1 * x 1 + PNT 2 * x 2 + PNT 3 * x 3}{PNT 1 + PNT 2 + PNT 3} \\ = \frac{\begin{matrix}( 1 + K ) * PT 1 * x 1 + ( 1 + K ) * \\ PT 2 * x 2 + ( 1 + K ) * PT 3 * x 3\end{matrix}}{( PT 1 + PT 2 + PT 3 ) * ( 1 + K )} \\ = \frac{PT 1 * x 1 + PT 2 * x 2 + PT 3 * x 3}{( PT 1 + PT 2 + PT 3 )} .\end{matrix} \qquad ( 2 )$$

Apparently, Formula (1) is the same as Formula (2). Therefore, the capacitive touch panel 2 according to the embodiments of the disclosure is not affected by the common-mode noise. The determined coordinates are not affected as long as the noise does not go beyond the dynamic range of a touch system.

One embodiment of the disclosure mainly describes differences of the embodiment with other embodiments, and the same or similar parts of the embodiments may refer to each other.

The disclosure may be practiced or implemented by those skilled in the art based on the above illustration of the disclosed embodiments. Various modifications to the embodiments are apparent for those skilled in the art. The general principle herein can be implemented in other embodiments without departing from the scope of the invention. Therefore, the present invention should not be limited to the embodiments disclosed herein, but has the widest scope that is conformity with the principle and the novel features disclosed herein.

1. A capacitive touch panel, comprising:
a printed circuit board;
a plurality of sensing electrodes located on the printed circuit board and arranged in a two-dimensional array; and
a touch control chip bound to the printed circuit board in a Chip-on-Board manner and connected to each sensing electrode via a wire.

2. The capacitive touch panel according to claim 1, wherein the touch control chip is configured to detect a self-capacitance of each sensing electrode.

3. The capacitive touch panel according to claim 2, wherein the touch control chip is configured to
drive each sensing electrode with a voltage source or a current source and
detect voltage, frequency or quantity of electric charge of each sensing electrode.

4. The capacitive touch panel according to claim 2, wherein the touch control chip is configured to
drive and detect a sensing electrode and simultaneously drive the rest of the sensing electrodes; or
drive and detect a sensing electrode and simultaneously drive sensing electrodes around the sensing electrode.

5. The capacitive touch panel according to claim 3, wherein the voltage sources or the current sources for all the sensing electrodes have a same frequency; or
the voltage sources or the current sources for all the sensing electrodes have two or more frequencies.

6. The capacitive touch panel according to claim 2, wherein the touch control chip is configured to detect self-capacitances of all the sensing electrodes simultaneously.

7. The capacitive touch panel according to claim 2, wherein the sensing electrodes are divided into a plurality of groups, each group comprises one or more sensing electrodes, the touch control chip is configured to sequentially detect self-capacitances of the one or more sensing electrodes in different groups and is configured to simultaneously detect the self-capacitances of the one or more sensing electrodes in the same group.

8. The capacitive touch panel according to claim 2, wherein the touch control chip is configured to determine a touch position based on a two-dimensional capacitance sensing array.

9. The capacitive touch panel according to claim 3, wherein the touch control chip is further configured to adjust sensitivity or a dynamic range of touch detection via adjusting one or more parameters of the voltage source or the current source, the parameter comprises any one or any combination of amplitude, frequency and time sequence.

10. The capacitive touch panel according to claim 1, wherein the sensing electrode has a rectangular shape, a rhombic shape, a triangular shape, a circular shape or an elliptic shape.

11. The capacitive touch panel according to claim 1, wherein the wire is connected to the touch control chip through a via hole.

12. The capacitive touch panel according to claim 1, wherein the printed circuit board is a double-layer printed circuit board, the sensing electrodes are located on a top layer of the double-layer printed circuit board, and the touch control chip is bound to a bottom layer of the double-layer printed circuit board in the Chip-on-Board manner.

13. A capacitive touch panel, comprising:
a printed circuit board;
a plurality of sensing electrodes located on the printed circuit board; and
a touch control chip connected to each sensing electrode and configured to detect a self-capacitance of each sensing electrode.

14. The capacitive touch panel according to claim 13, wherein the sensing electrodes are arranged in a two-dimensional array.

15. The capacitive touch panel according to claim 13, wherein the touch control chip is configured to simultaneously detect self-capacitances of the sensing electrodes.

16. The capacitive touch panel according to claim 15, wherein the touch control chip is configured to simultaneously detect self-capacitances of the sensing electrodes to ground.

17. The capacitive touch panel according to claim 13, wherein the sensing electrodes are divided into at least two groups, each group comprises one or more sensing electrodes, the touch control chip is configured to sequentially detect self-capacitances of the one or more sensing electrodes in different groups and is configured to simultaneously detect the self-capacitances of the one or more sensing electrodes in the same group.

18. The capacitive touch panel according to claim 17, wherein the touch control chip is configured to simultaneously detect self-capacitances of the sensing electrodes to ground.

19. The capacitive touch panel according to claim 13, wherein the touch control chip is configured to drive and detect a sensing electrode and simultaneously drive the rest of the sensing electrodes, or is configured to drive and detect a sensing electrode and simultaneously drive sensing electrodes around the sensing electrode.

20. The capacitive touch panel according to claim 16, wherein the touch control chip further comprises an electric charge receiving module, the electric charge receiving module is configured to detect quantity of electric charges transferred from the sensing electrode when a voltage applied to the sensing electrode is changed from a first voltage to a second voltage, and the touch control chip is configured to calculate the self-capacitance of the sensing electrode to ground by dividing the quantity of electric charges transferred from the sensing electrode by a difference between the first voltage and the second voltage.
